(19) United States
(12) Patent Application Publication
(10) Pub. No.: US 2008/0228580 A1
(43) Pub. Date: Sep. 18, 2008

(54) METHOD AND SYSTEM FOR COMPENSATING ONLINE CONTENT CONTRIBUTORS AND EDITORS

(75) Inventors: David Korman, Los Altos, CA (US); Frank Wells Sudia, San Francisco, CA (US)

Correspondence Address: David Korman, #288, 4546 B-10 El Camino Real, Los Altos, CA, 94022, US

(73) Assignee: Mynewpedia Corp., Tampa, CA (US)

(21) Appl. No.: 12/046,284

(22) Filed: Mar. 11, 2008

Related U.S. Application Data
(60) Provisional application No. 60/906,624, filed on Mar. 12, 2007.

(51) Int. Cl. G06Q 30/00

(52) U.S. Cl. 705/14

(57) ABSTRACT

A quantitative method of compensating contributors of digital content to an interactive online repository of digital content. The method includes receiving from a user a contribution of digital content. The method also includes assigning an initial point award to the user contribution an initial point award, imposing a vesting schedule on the initial point award, reviewing, by at least one of at least one editor and other users (peer review) of the digital content to determine ratings of the quality, suitability and appropriateness of the initial point award, vesting an increment of the point award, thereby making it available for conversion, converting, either by rule or upon user request of the points into things of value and withdrawing by the user of the things of value.

### FIELD OF THE INVENTION

The present invention generally relates to a method for operation and management of Websites on a global communication network, and more particularly to a method, system, apparatus, and computer program product that rewards users for contributing digital content or services that increase the Websites' value and utility for other users.

### BACKGROUND OF THE INVENTION

Dutta, et al. (U.S. Pat. No. 6,636,854) describes a system for augmenting conventional search engine results with peer-to-peer search results. Results from an index search and peer-to-peer search processes can be combined so that the user receives an augmented search result, wherein the server operator agrees to share a percentage of revenue with peer-to-peer nodes as an incentive to join its registered set of root nodes and expand its peer-to-peer connections.

User generated content is a major trend on the World Wide Web. Many Websites such as Digg.com, Huffington Post, Linkedin, MySpace, Revver, Wikipedia, and YouTube rely on gratuitous contributions of digital content and services from end users. In many cases Websites may experience increases in popularity, traffic, brand recognition, revenue, profitability, business valuation and attractiveness to employees, partners, and vendors based on user-supplied content. However, the limited quality and variety of content that users are willing or able to contribute gratuitously obstructs the further evolution of this trend.

User generated content and services can be divided into several major classes or domains, each of which may require different methods for management and contributor compensation.

Some content authorship categories include, but are not limited to:
computer games playable online or downloadable by the user;
computer models or parameters for financial and algorithmic trading;
computer source code, documentation, and compiled programs;
data feeds, such as sports scores, financial trading data, publication of privately negotiated trade prices;
digital education and training manuals, course materials, videos, and audio files;
digital entertainment content such as music, MIDI files, audio files, podcasts and videos;
digital objects usable in virtual environments, such as avatars, backgrounds, weapons, props, textures, sounds, and animations;
economic time-series data, economic models, and economic forecasts;
encyclopedia articles in human-readable text form;
informational compilations in machine-readable formats, such as repositories of semantic-Web formatted data;
model legal documents, practice guidelines and checklists, judicial and administrative law case reports;
news articles;
parameters for generating artistic renderings using fractal art or other programs;
real estate listings;
reviews of books, DVD's, eating and drinking places, hotels, movies, music CD′, performing arts, products, resorts, restaurants, schools, and services;
ring tones for cellular telephones;
still photography and graphic art;
stock and investment analysis and forecasts; and
weather data series, weather forecasting models, and weather forecasts.

This list of content types is not meant to be exclusive, as new or additional categories of digital UGC authorship can be expected to emerge.

In addition to content authorship, an online digital content management system requires a range of related services, for at least all the above-identified authorship categories, including but not limited to:
article and art editors, senior editors, and managing editors;
data quality editors and managers;
source code team leaders, code reviewers, project managers;
arbitrators and senior arbitrators to handle authorship, compensation, and policy disputes; and
business development administrators to negotiate terms with founders of incoming projects that may have complex payout models and/or multiple-tiers.

This list of services is not meant to be exclusive. New or additional categories of content administration services can be expected to emerge. An online digital content management system also needs a wide range of services to create and maintain its physical and logical infrastructure, which may include but are not limited to:
installation, setup and configuration of servers, firewalls, routers, switches;
administration of disk space and security settings on server and network components;
website administration;
design of logos, logotypes, trade dress, page layouts, style sheets;
administration of user ID's, roles, and privileges;
managed security monitoring, including intrusion prevention and detection, log management, incident response and remediation;
preparation of documentation and reports required by security and financial auditors;
handling contracts and interconnections with other service providers, including advertising servers, data feeds, and news feeds;
technical support for users; and
customer service for users needing assistance with user ID's and passwords, billing, system features and functions, non-standard transactions.

Free digital content offers little long-term incentive to content authors other than momentary notoriety or fulfilling a desire to remedy software market failure, since they cannot earn a living from it or support a family. Existing systems for soliciting, managing, offering, displaying or selling user generated content experience a range of problems, many due to inadequate revenue and/or compensation models:
corporations are reluctant to become too dependent on open source software because major open source licenses such as the General Public License (GPL) may require that all enhancements or linked programs be freely released, which poses major potential legal and competitive risks to proprietary software systems;
collaborative projects may fail to attract qualified programmers and other contributors, causing new releases, bug fixes, and security updates to be slower than desired;
authors whose early contributions may have initially made a given Website famous, popular, and successful get no higher reward than others;
the availability of free content drives down rates for content authors, such as professional photographers and graphic artists; and
financial resources are needed to edit the content, create and manage the Website, and enforce the terms of various free or paid-content licenses.

Zoetrope dot.com requires peer contributors to perform peer-review evaluations of other users' contributions as a condition for receiving similar evaluations, but more needs to be done.

Thus, by providing flexible models for user compensation, digital content added value can be more equitably rewarded.

### SUMMARY OF THE INVENTION

Accordingly, it is a principal object of the present invention to provide a flexible user compensation model for adding digital content value to Websites.

It is another principal object of the present invention to reward digital content Website contributors with things of value that continue to increase in value proportionally with the increasing popularity and success of the Website.

It is one other principal object of the present invention to reward early contributors for their assistance in making a Website successful.

It is yet another principal object of the present invention to provide rewards in the form of equity securities, whether represented as freely tradable shares, restricted stock, stock options, phantom stock, etc., of the corporation hosting the Website.

It is still another principal object of the present invention to reward user content generators with title to their user-generated content, and to share with generators the administration of sales and licensing of the content, in addition to any share of direct revenues the contributor may receive.

A quantitative method of compensating contributors of digital content to an interactive online repository of digital content is disclosed. The method includes receiving from a user a contribution of digital content. The method also includes assigning an initial point award to the user contribution an initial point award, imposing a vesting schedule on the initial point award, reviewing, by at least one of at least one editor and other users (peer review) of the digital content to determine ratings of the quality, suitability and appropriateness of the initial point award, vesting an increment of the point award, thereby making it available for conversion, converting, either by rule or upon user request of the points into things of value and withdrawing by the user of the things of value.

Definitions, as used herein:

| Term/Acronym | Definition |
|---|---|
| Conversion | Automatic or voluntary action to convert a reward point |
| | into a thing of value |
| Conversion | The ratio of reward points to things of value in effect |
| Rate | at the Time of Conversion |
| Follow-on view | A page that is viewed by a user subsequent to viewing |
| | an initial page on the same Website |
| Initial View | The first page viewed during a given session on a given |
| | Website, channel, or forum by a unique user |
| Including | “Including but not limited to” |
| PodCast | Any digital audio file, possibly a lecture or discussion, |
| | that a user can download and listen to on an Apple iPod |
| | or any other digital music player, including a personal |
| | computer |
| Stock | A class of equity securities of the sponsoring company or |
| | Website, or of any other company as may be mutually |
| | agreed |
| Time of | The time at which a reward point is converted into a |
| Conversion | thing of value |
| UGC | User-generated content |

Thus, the more important features of the invention have been outlined so that the drawing [symbol] thereof, following hereinafter, may be better understood. Additional details and advantages of the invention will be set forth, and in part appreciated from the brief description or by practice of the invention.

### BRIEF DESCRIPTION OF THE DRAWING

In order to understand the invention and see how it may be practiced, a preferred embodiment will now be described, by way of a non-limiting example with reference to the accompanying drawing, in which:

FIG. 1 is a general flow diagram of an exemplary method to compensate Website users for contributions of User Generated Content (UGC), digital content and services, performed according to the principles of the present invention;

FIG. 2 is a detailed exemplary flow diagram for algorithmically arriving at an initial value for a given user generated content contribution, performed according to the principles of the present invention;

FIG. 3 is a flow diagram for an exemplary judgmental assessment process for a given user generated content contribution, performed according to the principles of the present invention; and

FIG. 4 is an exemplary flow diagram for vesting; canceling and/or appealing of an award for user generated content contribution, performed according to the principles of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

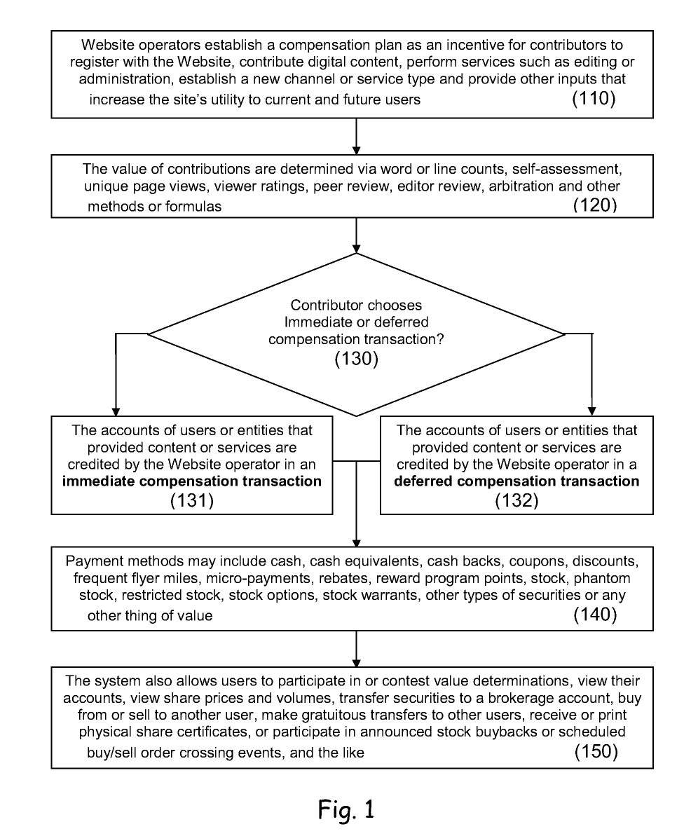

FIG. 1 is a general flow diagram of an exemplary method to compensate Website users for contributions of User Generated Content (UGC), digital content, and services, performed according to the principles of the present invention.

A method, system, apparatus, and computer program product are presented to compensate Website users for contributions of User Generated Content (UGC), digital content, and services. Rather than rely on gratuitous contributions of digital content and services from end users, Website operators can establish a compensation plan as an incentive for contributors to register with the Website, contribute digital content, perform services such as editing or administration, establish a new channel or service type, and provide other inputs that increase the site's utility to current and future users 110.

The value of contributions can be determined via word or line counts, self-assessment, unique page views, viewer ratings, peer review, editor review, arbitration, and other methods or formulas 120. The accounts of users or entities that provided content or services can be chosen 130 to be credited by the Website operator in an immediate 131 or a deferred 132 compensation transaction.

Payment methods may include cash, cash equivalents, cash backs, coupons, discounts, frequent flyer miles, micro-payments, rebates, reward program points, stock, phantom stock, restricted stock, stock options, stock warrants, other types of securities, or any other thing of value 140. The system also allows users to participate in or contest value determinations, view their accounts, view share prices and volumes, transfer securities to a brokerage account, buy from or sell to another user, make gratuitous transfers to other users, receive or print physical share certificates, or participate in announced stock buybacks or scheduled buy/sell order crossing events, and the like 150.

### Scoring Contributions

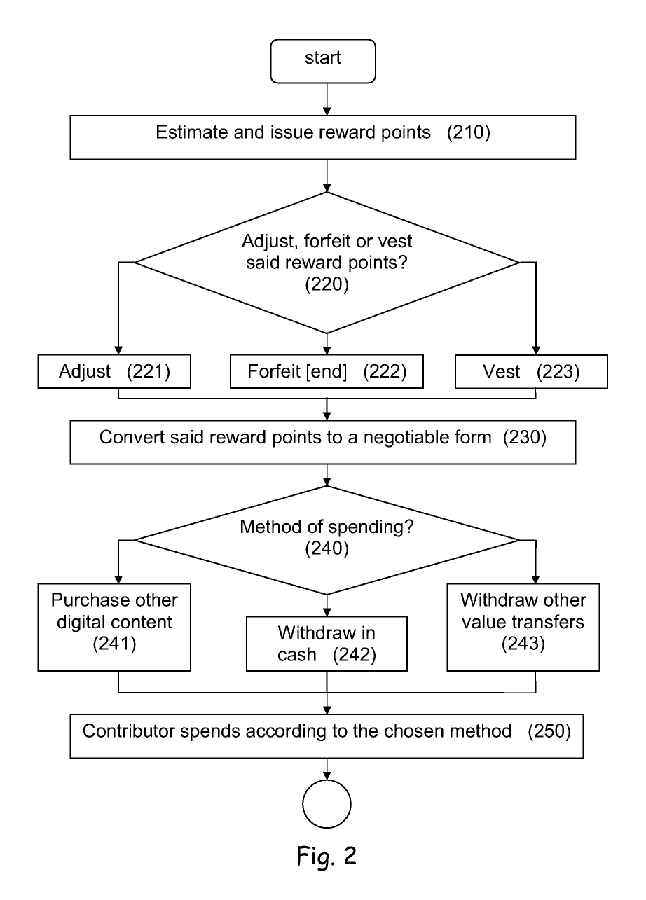

FIG. 2 is a detailed exemplary flow diagram for algorithmically arriving at an initial value for a given user generated content contribution, performed according to the principles of the present invention.

There is a non-limiting range of methods for arriving at the value of a given user generated content contribution. “Reward points” or cash, cash equivalents, or stock can be used to directly award and administer the value of contributions.

A method for arriving at an initial value for a given user generated content contribution, according to a preferred embodiment of the present invention, comprises:

(a) estimating and issuing reward points 210;

(b) choosing 220 between adjusting 221, forfeiting 222 or vesting 223 said reward points;

(c) converting said reward points to a form negotiable in the spending step 230;

(d) choosing to spend 240 by the user contributor in at least one of the following ways:
purchasing other digital content within the system 241;
withdrawing in cash 242; and
withdrawing by various other kinds of value transfers 243; and

(e) spending by the contributor according to the chosen method 250.

“Scoring Contributions” are concerned with initial issuance of estimated, unadjusted, and unvested reward points.

Quantitative Metrics
Text articles such as encyclopedia entries, features, news stories, reviews, or the like can be initially scored by the number of words, similar or identical to standard “pay by the word” formulas commonly used by many print publications. A rate table is established for each category or subcategory of material. For example, a feature article rate of 10 points a word will be established, such that the contributor of a 2,000 word article will receive an initial issuance of 2,000 points. (If at the time of conversion the rate were US $0.10 per point, then 2,000 points would equal US $200.00.).
Photographs, graphic art, charts, etc., whether or not animated or submitted in conjunction with an article, can likewise be scored based on standard rates paid by magazine publishers for similar items, in association with similar content.
Software source code can be initially scored by the number of lines written, which is a commonly used metric in the global software industry. For example if, for a given class of software, product or project the rate of US $1.00 per line were established, then if a computer programmer submitted a program of 2,000 lines, and if at the time of conversion the cash value of a reward point were US $0.10, the contributor receives an initial issuance of 20,000 reward points.
In a social or professional networking Website, users can enhance the site's perceived value to other users by listing themselves and by “linking” with other users. (Examples: MySpace, Linkedin.) This form of contribution can be scored according to an algorithm that establishes base awards for creating home pages or profiles with a minimum level of detail, plus additional awards for each link or connection established with another valid user, and profile enhancements such as letters of recommendation.

Judgmental Assessments

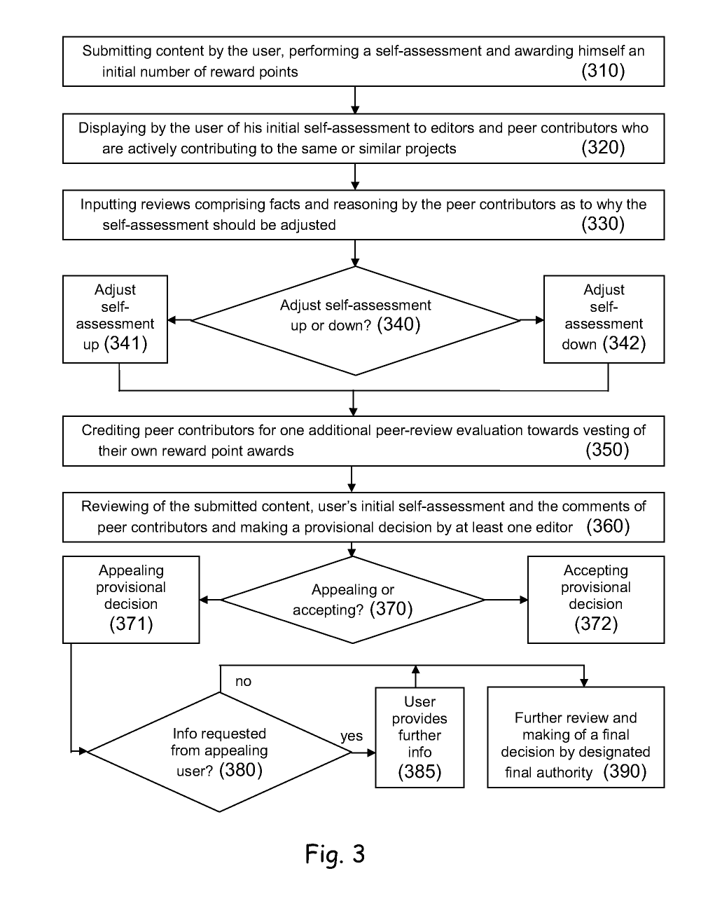

FIG. 3 is a flow diagram of an exemplary judgmental assessment process for a given user generated content contribution, performed according to the principles of the present invention.

Other forms of UGC content may not lend themselves to direct algorithmic scoring, yet may be amenable to judgmental scoring according to published guidelines. In some cases user groups may elect a judgmental approach in lieu of an algorithmic one. Under this approach, the Website operator publishes procedures, processes, parameters, and/or factors for initial value assessments, and adjustments as more fully discussed below, of user submitted content.

### In a Preferred Embodiment

the user submits content, performs a self-assessment and awards himself an initial number of reward points 310;
the user displays his initial self-assessment to editors and peer contributors within the system who actively contribute to the same or similar projects 320;
the peer contributors post reviews comprising facts and reasoning as to why the self-assessment should be adjusted, 330 and making the adjustment 340 either up 341 or down 342;
the system requires that said peer contributors perform a certain number of peer-review evaluations for other users' contributions as a condition for vesting their own reward point awards 350;
at least one editor reviews the submitted content, the submitting user's initial self-assessment and the comments of peer contributors and makes a provisional final decision 360;
the submitting user chooses to accept the provisional final decision, either affirmatively or, if not appealed within a given time limit, by default, thus making it final 372; or the user may initiate a process to appeal the decision 371, to a higher editor or editorial board, to a body of company management, or to a panel of arbitrators established by the Website operator; and
persons responsible for the appeal process may requests information request information from the appealing user 380, and if so the user may provide information 385.
Any other party may hold a hearing, if requested or feasible. The hearing may be telephonic or in person.

Under the rules of the Website the decisions of management or the panel of arbitrators will be final and binding 390. Typically such panels will employ persons who are broadly experienced in the relevant law and adjudicative procedures, whose decisions will be entitled to general respect.

If requested by the user, or provided by the Website's rules and user agreements, the decision or a summary thereof may be published in an archive for future reference, and may acquire the status of a precedent that can be cited in future cases.

Views, Downloads, and Ratings
The value of points awarded to viewable or downloadable content, during an initial or subsequent time period, can be based on:
its popularity as measured by page views, downloads, or hours of user interaction;
user input of quality ratings, such as a scale of 1-to-5 stars;
user binary input using “1” for content of particular interest and a default of zero for mediocre or unread content; (These binary inputs may be popularly known as “Diggs,” after the widely-imitated Website Digg.com that popularized this ratings model.) and
other user feedback inputs or ratings including abusive, duplicate, erroneous, illegal, lame, mis-categorized, spam, unworthy or the like.

Care must be taken to minimize the possibility of click-fraud, where the submitting user, his friends or confederates may defraud the Website by generating apparent but phony user interest to boost their payouts under the compensation system. Technical measures to combat click-fraud may include but are not limited to:
requiring all users who enter scoring inputs to register and obtain unique user ID's linked to identifiable information such as e-mail or postal addresses that can be confirmed with mail backs;
requiring all users who enter scoring inputs to periodically pass “human tests” such as entering the value of obfuscated letters or numbers that for non-human users are hard to decipher;
regularly collecting and analyzing the IP addresses of users that enter scores, to determine if unusual numbers of such inputs are coming from single IP addresses, or from regions of the world whose native language is not the same as the content being scored, etc; and
looking for other anomalous patterns of activity that might suggest fraud, including access at unusual times of day in the user's locale or continual access over a period that would normally require the user to sleep, etc.

Revenue Generated
Yet another method for determining an initial value of reward points is based on revenue generated by the content during a specified initial or subsequent period. Common sources of revenue from Web-based digital content include:
advertising revenue associated with the contributed page being viewed or content being downloaded. Advertisements may be in any form, including banner ads, cross-bars or side-bars of textual ads, pop-ups or pop-unders (although these tend to be unpopular with end users), mouse-overs that appear when a mouse cursor is positioned over a specified area, and fixed or animated ads placed in or near textual content in a manner similar to the layout of a printed magazine;
paid user or company subscription fees for access to premium content, typically paid in advance for a specified period and billed to credit cards;
referral fees from partner programs such as Amazon Associates and Google or Yahoo! search boxes payable based on activity referred from the source Website to the partner's Website;
commercials inserted before, after, or in the middle of video or audio content;
advertisements or product placements in single or multi user online gaming environments, virtual worlds, or other animations;
sales for cash of stock photographs, videos, financial data, financial predictions or analyses, computer programs, financial or economic models, etc.;
license revenue, including fees received from consumers or companies for software product licenses, including support and maintenance fees;
fees for use of gaming environments, virtual worlds, analysis of data, and the like;
fees for training courses, educational seminars, professional education, mandatory continuing legal education, remedial education including courses for reduction of traffic violation license points, and the like.

These examples of revenue types are only intended to illustrate the principle of awarding points to user generated content based on its performance in regard to revenue generation. Other forms of revenue generation are possible and new forms will likely be developed in the future.

Based on the foregoing, initial reward points might represent some fraction of the revenue received or accrued during an initial or subsequent period. For example, if on the conversion date the value of a reward point was US $0.10, and during the first three months a given item of UGC generated US $5,000.00 in revenues, and the posted schedule provided that users would be awarded 50% of this value, then the system would compute and record an initial award of 50,000 points to the submitting user.

The system of the present invention provides means to receive input data, formulas, and procedures for a given; content type, apply the rules and procedures of such model, compute an initial estimated award value, and record the resulting initial awards in the account of the submitting user in association with a list or lists of their recently or historically submitted content.

The foregoing models for compensating UGC contributors are illustrative only and new models for compensation are expected to emerge or be developed.

### Reward Point System Administration

The Website operators, including senior and managing editors, can from time to time adjust the algorithms, judgmental rules, vesting schedules, conversion rates and procedures for the reward point system.

Content value scoring algorithms and methodologies may be revised or adjusted from time to time based on various factors including but not limited to:
the actual or perceived effectiveness of a given scoring method;
user, editor, administrator, or licensee suggestions;
changes in industry practices; and
emergence of new or modified content types.

Reward point values and conversion schedules may be revised or adjusted from time to time based on various factors including but not limited to:
supply and demand for various types of content or premium content;
the “shelf-life” of the content, which may be brief for popular culture but long for
training courses in accounting or car repair, etc.;
changes in the Website's or channel's popularity and traffic;
changes in the absolute or relative value of things into which the reward points may be converted; and
currency exchange rate or interest rate fluctuations.

A less popular Website or channel may need to offer and pay more to attract contributions, whereas a highly popular Website or channel may lower the value of a given contribution.

The editors or administrators of a channel or forum may wish to establish differential pay rates for contributors who may be famous, better looking, highly skilled, educated, widely published in scholarly media, and the like. In a preferred embodiment the administrators will publish a list of such criteria and of the resulting differential point awards for contributors.

The system of the present invention provides means, such as Web screens, to view the current point system parameters, produce and review reports and analyses on its functioning, or how it would function under different scenarios, and input new rules and parameters to put such adjustments into effect.

### Forfeitures and Adjustments

The establishment of an initial point award value for a given item of UGC is a common first step under the system of the present invention. In a preferred embodiment it is only the beginning because the accession, processing, and monetization of UGC carries risks and hazards that must be managed to assure fairness to the system operators, other submitters, public users, downstream clients and licensees, the general public, and others.

Such risks may include but are not limited to cases where:
the contributor claims authorship of an item that was in the public domain, subject to copyright, trade secret, or license rights of another, or subject to a free “copyleft” license such as a variant of the Gnu Public License (GPL), Gnu Free Documentation License (GFDL), Creative Commons (CC) License, etc.;
the content is offensive, criminal, libelous, defamatory, constitutes personally identifiable information, violates the privacy rights of a non-public figure, is pornographic other than in a channel or forum that expressly permits such content, or was obtained in violation of law, etc.;
the content is of poor quality and requires minor, moderate, or major editing or revision before it meets the editorial standards of the Website, channel, or forum to which it was submitted, according to the discretion of editors responsible for such Website, channel, or forum;
other users for any reason or for no reason make extensive substantive revisions or additions to the content under a multi-user wiki type editing system;
the content consistently receives low, negative, or no user ratings or page views;
the content is a duplicate submission, was submitted to related channels or Websites, or was submitted to any other venue where the policy of the channel prohibits multiple submissions of the same content, e.g., a scientific paper;
the content is redundant with previously submitted content;
a later submission of similar content is deemed to be of better quality; and
the forum or channel to which the content was submitted, which may include a forum or channel created by the submitting user, is discontinued for any reason or for a list of specified reasons.

Short of forfeiture, an initial award of reward points may be adjusted downward or upward based on:
for an article, the number of words changed or deleted by subsequent editing of that article during a given period of time, whether by formally appointed editors or by other users in a multi-user Wiki type editing system;
for a source code file, the number of lines or characters changed or deleted by subsequent editing of that program, during a given period of time, whether by formally appointed editors or by other users in a multi-user source code management system;
subsequent or ongoing page views, follow-on views, downloads, user ratings, advertising revenue, partner/referral revenue, or licensing revenue;
for an online accessible program, the number of times a given program feature is accessed or executed due to end user actions;
for a home page in a social or professional networking site, if any other users unlink from the page;
later received judgmental comments suggesting that the initial award was too high or too low, for example because the content made an outstanding contribution to the success of the forum or of associated content; and
a situation wherein the content becomes famous and attracts initial page views that lead to follow-on views of other, non-famous, content by the same viewers.

### Vesting Schedules

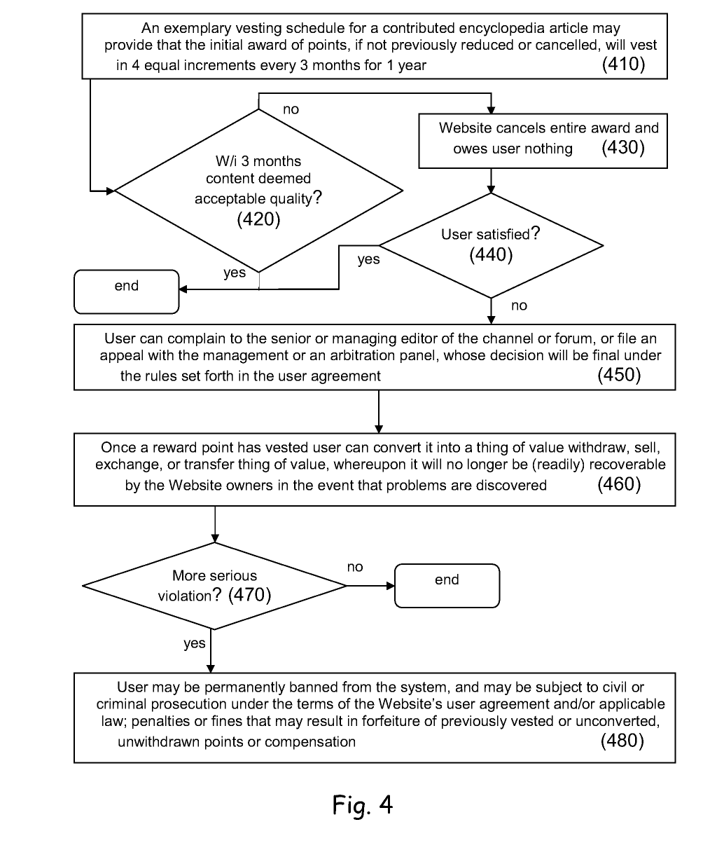

FIG. 4 is an exemplary flow diagram for vesting, canceling and/or appealing awards for user generated content contributions, performed according to the principles of the present invention.

To address the above mentioned and other risks, and allow retrospective point adjustments, in a preferred embodiment the initial point awards are subjected to a vesting schedule which, for a given type of UGC, is designed to mitigate its associated legal and other risks, as discussed above.

Under a vesting schedule reward points initially awarded to a submitter of UGC, for a given item of content, will remain nontransferable, non-withdraw-able, and subject to forfeiture for specified times, allowing Website operators to determine whether any conditions or reasons for forfeiture or adjustment may apply.

For example a vesting schedule for a contributed encyclopedia article may provide that the initial award of points, if not reduced or cancelled, will vest in four equal increments every three months for one year 410.

TABLE I

| | Time | | | | |
|---|---|---|---|---|---|
| | 3 months | 6 months | 9 months | 12 months | TOTAL |
| Amount Vested | 25% | 25% | 25% | 25% | 100% |

Thus, if within the first 3 months the Website decides 420 the content is plagiarized or otherwise of unacceptable quality, it can cancel the entire award and owe the user nothing 430. If he or she remains dissatisfied 440, the user can complain to the senior or managing editor of the channel or forum, or file an appeal with management or an arbitration panel, whose decision will be final under the rules set forth in the user agreement 450.

Once a reward point has vested, the user can convert it to a thing of value and then withdraw, sell, exchange, or transfer that thing of value whereupon, if problems are discovered, it will no longer be readily recoverable by the Website owners 460.

In case of more serous or intentional violations 470, the rules may also provide for penalties or fines that could result in forfeiture of previously vested or unconverted, un-withdrawn points or compensation.

For serious and willful offenses, including but not limited to plagiarism, click fraud, repeated rule violations, implanting computer malware or spyware in submitted content, privacy violations, impersonation of other users, creating false user accounts, subversion of security systems, or unauthorized access, the user may be permanently banned from the system, and may be subject to civil or criminal prosecution under the terms of the Website's user agreement and/or applicable law 480.

### Conversion to Compensation

Once a UGC contributor has submitted content, received an initial point award, waited through the imposed vesting schedule, and risked possible adjustments or forfeitures, the point award will vest and may be converted into a thing or things of value, and possibly be retained in the user's account, withdrawn, spent, or exchanged, etc., as further described below.

### Time(s) of Conversion

Conversion of points to things of value may in principle occur at any time between award and withdrawal or exchange. In a preferred embodiment, the system of the present invention will provide the contributor with a possibly revocable election to convert his or her points, or what may remain of them, at a conversion rate that was current:
when the contribution was input;
when the contribution was reviewed and accepted by an editor;
when the points vested; or
when the user took action after vesting to convert the points into things of value.

Fixation of the conversion rate could occur at any arbitrary time after award prior to final withdrawal or transfer. However the four times above will be easiest to administer.

### Founder Groups/Multi-Level

In a preferred embodiment, the present invention provides means for creating multi-tier compensation plans, for example to provide enhanced compensation to a user or group of users who serve as the founders of a given project, forum, or channel.

For example:
in a collaborative UGC software development project, there is often one or a small group of users who create and upload an initial or alpha version of the proposed software, and then solicit other programmers or users to collaborate in the design, programming, testing, and support of more enhanced versions;
a user, a small group, or even a company may create and publicize a discussion forum on a new or specialized topic, and administer and moderate the forum, thereby becoming its first editor(s); and
a group of content editors, in any cultural or technical field, may create an online publication, such as an e-zine, blog or blog aggregation site, publicize it and solicit contributors, viewers, and advertisers.

In these and other cases the parent Website will want to provide and administer enhanced compensation to such a founder or founder group, in view of the substantial value added to the overall site by such activity. This is similar to a situation in which the parent Website corporation merges with or acquires (M&A) an existing project or company in return for cash, the parent's stock, and/or other compensation, including an earn-out based on subsequent performance of the acquired activity.

In a preferred embodiment the system of the present invention provides means to:
award, in the discretion of a senior editor, managing editor, or management, and subject to a negotiated vesting schedule, a lump sum of initial reward points to the founder, founder group, or company in return for placing their activity on the parent's site, and
award to the founder or founder group an “override” based on a percentage of the reward points awarded to users who contribute their UGC content under the hosted activity.

For example, suppose an editor group controls an existing e-zine with an established reputation and user base. If the current conversion value of a reward point is US $0.10 the managing editor or management may award (a) an initial point award of 500,000 points, subject to vesting, to be allocated into the personal user accounts of the editor group, and (b) a 20% override or commission on all UGC submissions received from other users, based on reward points actually and ultimately vested into the accounts of such UGC contributors, as long as the editor remains actively associated with the project and the project remains hosted on the parent site.

Conventionally, an acquirer could compensate the contributors by sharing advertising, user subscription fees, or license revenue. However this will not give the contributors any share of the incremental value of the hosting Website's stock, which is generally a multiple of revenue. Thus in many cases the acquirer will be better off paying for the acquisition in stock, thus maximizing net revenues, and the contributors will be better off with the stock, which may provide a greater and more immediate value than the future revenue stream. Yet by themselves the majority of such activities are too small on their own to warrant issuance of publicly tradable stock.

### Editorial and Administrative Tasks

The system of the present invention may also be used to compensate of editors, administrators, and technical personnel whose efforts are essential to the functioning of the online content repository. It is generally necessary and desirable that such persons have adequate professional qualifications and experience in the field relating to the form of digital content they are asked to administer.

They may take on several levels of responsibility, ranging from that of an individual content-contributing user reviewing other users' submissions, possibly as a condition of their own awards vesting, up through a manager who makes critical policy decisions on scoring methods, initial reward point awards, vesting schedules, forfeiture policies, terms of use, advertising and trade dress, copyrights and trademarks, page format, task assignments, review and compensation of junior administrators, and more, generally for a defined topic, sub-topic, forum, or channel within the context of the sponsoring site.

In a preferred embodiment of the system of the present invention, the most senior managers and system administrators will define and establish the boundaries of content domains, the minimum qualifications of editors or administrators in such domains, a schedule of tasks to be performed by such personnel (users), and initial amounts of reward points to be awarded upon completion of such tasks, including vesting schedules and any conditions for forfeiture or adjustment of such awards based on subsequent events. The system provides means whereby multiple tiers of more senior managers and system administrator-users can establish the task lists and award rates for more junior administrator-users beneath them, with or without delegating the ability to set such policies for any further tiers below.

In the next version of this application we will provide examples of task lists and compensation rates, vesting schedules, etc., for several illustrative domains.

### Policy and Rate Administration

In a preferred embodiment, the system of the present invention provides means whereby senior managers of digital content can, for each given subject matter, channel or forum input, review efficacy via historical and theoretical scenarios and adjust as shown in Table II below:

TABLE II

| | |
|---|---|
| for initial | UGC point award formulas, vesting schedules, |
| contributors | conditions of forfeitures and adjustments, etc.; |
| for editors | domain boundaries, required qualifications, lists of |
| and administrators | task types, compensation rates, including overrides |
| | on UGC awards in the domain, etc.; |
| for customer | domain boundaries, lists of task types, |
| and technical | compensation rates, required qualifications, etc., |
| support personnel | but without overrides on UGC awards. |

### Stock Award Plans

The Board of Directors of the digital content repository's sponsoring corporation, or the Boards of Directors of any other participating or affiliated corporations, will approve a stock compensation plan (“the Plan” ) specifying the classes and available amounts of equity securities, debt securities, stock options, phantom stock, stock warrants, cash, or other things of value, along with guidelines for the initial awards of UGC and personnel reward points, vesting schedules, forfeiture and adjustments, times of conversion, and other provisions for stock plan administration.

No stock may be converted in excess of the amounts authorized in the Plan by the Board and in the Corporation's Certificate of Incorporation. The system of the present invention in a preferred embodiment provides means to input the currently authorized, issued and un-issued amounts of the various types of compensation approved for issuance and conversion under the Plan as in effect from time to time.

In addition, means will be provided to track the amounts of unvested and unconverted reward points and their likely rates of conversion. Means will also be provided to estimate whether and how soon the Corporation is likely to run out of authorized but un-issued equity securities available for conversion of user and administrative reward points scheduled to vest in forthcoming periods.

If there are multiple corporate issuers, classes of equity or other securities into which reward points may be converted, and/or trading venues where the stock is listed, which may apply based on differing classes of users, user geographic locations, content types, or other factors, the system will provide means for each user to determine and/or select, at the times of initial award and/or conversion, the available target securities or things of value into which they may elect to have their reward points converted.

### Trading Venues

The Corporation, and any participating or affiliated corporations, may wish to list its stock for public trading on multiple stock exchanges around the world, including AIM (London), Dubai, Frankfurt, Hong Kong, Mumbai, OTCBB or Nasdaq (US), Singapore, Tokyo, or others, because for the users to most efficiently convert their reward points into things of value it may be preferred that such things of value are securities that trade on a stock exchange that is geographically closer to the user, and can tap into pools of liquidity in the geographic region.

This is especially true of content in non-English languages, with non-US and/or non-European target markets, since it may be more likely that investors who speak fluent Chinese or Arabic will be more capable of accurately analyzing and therefore placing a higher value on digital content provided in their regional language.

### User Account Functions

The user account management system of the digital content management Website of the present invention, in a preferred embodiment, may resemble the functionality of an online brokerage application, and may include

Stock Price & Company Information

Upon valid sign-on the registered contributor or editor will see the current stock prices of all issues and classes of stock that are applicable, i.e., have been or may be awarded to him or her, along with charts, statistics, news, financial statements, and regulatory filings relating to those securities.

Normally this information will not be shown to non-contributing users of the digital content repository, so as not to distract from their preferred task of locating and viewing, downloading, or otherwise interacting with the digital content.

View/Manage Contributions

Means are provided to allow the user to view and manage his or her r content contributions or other tasks performed, initial reward point awards for each item, vesting schedules, forfeitures or adjustments, and initiate appeals of adjustments, etc.

In a preferred embodiment the contributing user will also be presented with a queue of workflow tasks involving reviewing and commenting on digital UGC contributed by other users, including any proposed self assessment initial awards, with fields to input comments and, if the content is hosted in a Wiki style editing environment, an opportunity to edit the other user's submission.

Convert Points to Compensation

Means are provided to allow the user to convert reward points into things of value, possibly including a range of equity securities trading on a range of global trading venues, either automatically by establishing his or her conversion preferences, or manually by selecting a desired target thing of value at the time of conversion.

If there is only one or a small range of choices the user may have no effective choices and may be required to automatically convert into a single target security at the time of vesting.

View Account Holdings

Once the points have been converted to things of value, the system provides means for users to view their holdings, in the manner of a conventional brokerage account. Initially such securities or cash will be designated on the books of the company, located in a company master securities account at a brokerage firm or depository, and not immediately available to the user for any other purpose-prior to performing a withdrawal transaction.

Withdrawal Methods
The system provides means for users to withdraw their things of value by initiating one or more types of withdrawal transactions, including:
selling the securities or things of value for cash at the current market price;
withdrawing cash by check or transfer to a pre-defined PayPal or a conventional bank account;
transferring the things of value gratuitously to another pre-defined user account;
transferring securities or cash to a pre-defined brokerage account, from where they can be held, managed, or sold; and
when allowed by applicable law, printing an actual stock certificate whereupon the shares will be withdrawn from the user's online account and will thereafter be represented by the physical share of stock so printed, with its serial number and number of shares recorded in the company's stock ledger and the shareholder's address for receiving mailings directly.

In cases involving the transfer of securities to a brokerage account, the transfer of cash to bank accounts, or the printing of physical stock certificates, a back office settlement cycle will be provided to allow the correspondent parties to receive pre-formatted digital files containing information needed to effectuate the transfer. When a stock certificate has been printed the company's transfer agent will update their records to note that this action has occurred.

The user account view system will provide means for the user to review records of past transfers and withdrawals for a required period of time, such as 3-7 years. In addition most or all transfers or other actions will generate confirmatory e-mails to the user's designated e-mail account, and higher risk transactions may require re-confirmation after receipt of such e-mail.

Sponsored Order-Crossing

It may be undesirable to provide small amounts of stock to large numbers of contributors, since they will often attempt to immediately sell it, potentially depressing the price and diminishing their reward for UGC content or services. Whereas if the stock is listed for sale in a more widely advertised forum, or if other contributors see value in the stock and wish to purchase it, the sponsoring Website may provide means to conduct a regularly scheduled order-crossing event. Such an event will nominally be limited to registered users, although becoming such a user is not difficult, or to other users that may have registered with the site as brokers, market makers, or investors (collectively “Other Users”) for the sole purpose of participating in such events. Preferably such Other Users may only enter buy orders.

The system provides means to publicize the date of the order-crossing event in advance, to allow each user or Other User to enter orders to buy or sell each class of securities or other applicable things of value. Then, at the predetermined time, the system matches all or as many buy and sell orders as possible, preferably using a Dutch Auction algorithm to establish a price that will clear all the orders in any given security.

If there is a significant imbalance of buy or sell orders, the sponsoring Corporation may, but is not obligated to, offer to purchase or sell such numbers of each applicable issue or class of securities as may be needed to provide for an orderly market.

To further assure the fairness of such an order crossing event the Corporation may retain the services of an investment bank to provide an opinion regarding fair market value of the securities to be exchanged as of the proposed exchange date, based on information about the Corporation and its operations. This may be highly desirable in the case of an unlisted security.

Purchases or sales of securities through the Website, whether or not arising from an order crossing event, will settle in accordance with settlement rules and timeframes applicable to the jurisdictions in which participating users reside. Typically these require that participating users deliver the cash or securities to a specified party within 4 business days. The system provides means to generate digital files acceptable to such parties to notify them of items expected to be received and delivered.

### Same-Site or Related-Site Purchases

As an alternative withdrawal method the system provides means for the user to pay for purchases of digital content or anything else available on or through the sponsoring Website. These purchases may be for cash or cash equivalents, or for fully vested but unconverted reward points, if the seller will accept them as a form of payment.

Thus for example, in addition to purchases of digital content, the sponsoring site may be able to negotiate relationships with other Web based e-merchants such as Amazon dot corn or eBay dot corm, whereby account-based cash or unconverted reward points may be used as payment on their Websites. A settlement cycle is provided whereby the sponsoring Website and the selling Website reconcile the transaction and debit the buyer's account.

### System Security Methods

In view of the tremendous number and severity of reported and unreported attempts to gain unauthorized access to networked systems and resources of any kind, and especially to accounts from which money or things of value may be stolen by a wide range of means, it is important for any Internet accessible financial system to employ a high level of security from electronic attacks.

In particular many financially related systems appear to be vulnerable to attacks whereby the adversary compromises the user's personal computer and installs a keystroke logger that can capture the user's typing inputs including their ID and password for a given URL or Website address. Then if such URL points to a system of financial accounts, the adversary may either compromise that account or sell the access credentials to another attacker who has a better conceived plan of attack.

The system of the present invention will provide state of the art financial grade security, including at a minimum:
formal ID administration;
role-based access;
2-factor ID, optional;
firewalls, DMZ's, and application servers;
server and database monitoring, e.g., TripWire;
inactivity timeouts;
logout buttons on every screen that displays or can access financial information;
minimum password length and difficulty;
6-digit′ length or more for numeric PIN's; and
scheduled password changes, e.g., every 90 days.

In a preferred embodiment the system of the present invention provides for display to an end user an account login screen that includes a scrambled PIN pad, wherein:
the user has selected or received a pre-determined 6-digit PIN;
the system displays to the user a scrambled PIN pad in graphical form;
the PIN pad displays the 10 Arabic numerals in a scrambled order;
the numerals are obfuscated to render them difficult to read by a non-human program; and
the codes returned due to mouse clicks on numerals are also randomly pre-determined by the system for this unique login attempt.

Thus when the human user clicks on the obfuscated, randomly shuffled buttons, which may be irregularly shaped to further deter analysis by adversarial programs, the program returns to the Website a set of codes based on a vector of codes downloaded from the system for this particular login attempt.

Additional means may be employed to increase the difficulty of capturing, harvesting, and maliciously misusing the user's login credentials, including additional white box, black box, and other software obfuscation techniques.

### REFERENCES CITED

American Zoetrope (zoetrope dot com), [member film script review policies];
Dutta, et al. [U.S. Pat. No. 6,636,854 ] Method and system for augmenting web-indexed search engine results with peer-to-peer search results. (Oct. 21, 2003);
Linkedln.com, [user agreement]; and
Revver.com, “Revver Member Agreement,” downloaded Mar. 4, 2007.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A quantitative method of compensating contributors of digital content to an interactive online repository of digital content, comprising the steps of:
receiving from a user a contribution of digital content;
assigning to the user contribution an initial point award;
imposing a vesting schedule on said initial point award;
reviewing, by at least one of at least one editor and other users (peer review), the digital content to determine ratings of the quality, suitability and appropriateness of the initial point award;
vesting an increment of said point award, thereby making said point award available for the following conversion step;
converting by one of rule and upon user request of said points into things of value; and
withdrawing by the user of said things of value.

2. The method of claim 1, further comprising adjusting the initial point award if deemed necessary based on said reviewing step and at least one pre-determined factor.

3. The method of claim 2, wherein the adjusting step is done automatically.

4. The method of claim 2, wherein the adjusting step is done manually.

5. The method of claim 2, wherein the adjusting step is done automatically

6. The method of claim 1, wherein the step of assigning the initial point award is performed by calculating the number of words in the contribution and multiplying it by a pre-determined number of points per word.

7. The method of claim 1, wherein the step of assigning the initial point award is performed by calculating the number of lines of computer code in the contribution and multiplying it by a pre-determined number of points per line.

8. The method of claim 1, wherein the step of vesting an increment of the point award for a given user is made conditional on said user performing the step of reviewing the quality of one or more submissions of similar content by other users.

9. The method of claim 1, wherein said reward points are awarded to viewable content can be based on, during an initial or subsequent time period

10. The method of claim 1, wherein said viewable content is downloadable content.

11. The method of claim 1, wherein the popularity of said content is measured by at least one of page views, downloads, and hours of user interaction.

12. The method of claim 1, wherein user input of quality ratings is on a scale of 1-to-5 stars.

13. The method of claim 1, wherein one of the things of value is cash.

14. The method of claim 1, further comprising forfeiting point award.

15. The method of claim 1, wherein said ratings of quality comprise one of positive ratings and negative ratings.

16. The method of claim 15, wherein said negative ratings comprise at least one of abusive, duplicate, erroneous, illegal, lame, mis-categorized, spam and unworthy.

17. The method of claim 1, further comprising requiring all users who enter rating inputs to register and obtain unique user ID's that are linked to identifiable information comprising at least one of e-mail and postal addresses that can be confirmed with mail backs.

18. The method of claim 1, further comprising requiring all users who enter rating inputs to periodically pass “human tests” comprising at least being required to input the value of at least one of obfuscated letters and numbers that are difficult for non-human users to decipher.

19. The method of claim 1, further comprising requiring regularly collecting and analyzing the IP addresses of users inputting rating inputs to determine if unusual numbers of said inputs are coming from one of single IP addresses and regions of the world whose native language is not the same as the content being rated.

20. The method of claim 1, further comprising requiring looking for anomalous patterns of activity possibly suggesting fraud, comprising at least access at unusual times of day in the user's locale.

21. A judgmental method for arriving at an initial value for a given user generated content contribution, said method comprising:
submitting the content by the user, performing a self-assessment and awarding himself an initial number of reward points;
displaying by the user of his initial self-assessment within the system to editors and peer contributors actively contributing to the same or similar projects;
inputting reviews comprising facts and reasoning by the peer contributors as to why the self-assessment should be adjusted either up or down;
requiring by the system that said peer contributors perform a certain number of such peer-review evaluations of other users' contributions as a condition for the vesting of their own reward point awards;
reviewing of the submitted content, the submitting user's initial self-assessment and the comments of peer contributors and making a provisional final decision by at least one editor;
appealing said decision by the user;
requesting information from the appealing user by the persons responsible for the appeal process; and
accepting by the submitting user of the provisional final decision, thus making it final.
